(19) United States
(12) Patent Application Publication
(10) Pub. No.: US 2015/0219950 A1
(43) Pub. Date: Aug. 6, 2015

(54) DISPLAY DEVICES AND METHODS OF MANUFACTURING DISPLAY DEVICES

(71) Applicant: SAMSUNG DISPLAY CO., LTD., Yongin-City (KR)

(72) Inventors: Jun-Woo Kim, Cheonan-si (KR); Sung-Chul Kim, Busan (KR); Tae-Soo Kim, Seoul (KR); Jun-Hyeog Song, Seoul (KR); Ho-Jung Lee, Yongin-si (KR)

(21) Appl. No.: 14/299,758

(22) Filed: Jun. 9, 2014

(30) Foreign Application Priority Data
Feb. 5, 2014 (KR) 10-2014-0012901

(51) Int. Cl. G02F 1/13363; G02F 1/1335

(52) U.S. Cl. CPC G02F 1/13363; G02F 1/133528; G02F 1/1336

(57) ABSTRACT

A display device includes a display panel, an adhesive member, a transparent member, a shielding member, a phase retardation layer, and a linear polarization layer. The adhesive member may be on the display panel. The transparent member may be positioned on the adhesive member. The shielding member may be located beneath a lower surface of the transparent member in a peripheral region. The phase retardation layer may be located between the display panel and the adhesive member. The linearly polarizing layer may be located between the adhesive member and the transparent member. The linearly polarizing layer may be partially overlapped with the shielding member.

### CROSS REFERENCE TO RELATED APPLICATION

This application claims priority to and the benefit of Korean Patent Application No. 10-2014-0012901 filed on Feb. 5, 2014, the disclosure of which is hereby incorporated by reference herein in its entirety.

### BACKGROUND

1. Field

Example embodiments of the present invention relate to display devices and methods of manufacturing display devices.

2. Description of the Related Art

A polarizer of a display device is positioned between a display panel and an adhesive member (e.g., resin) or an optical clear adhesive (OCA). In this case, there is a region of the display device where a shielding member (e.g., the shielding member may be located in a peripheral region, and the shielding member may cover lateral portions of electrodes and the polarizer located in the peripheral region) may be overlapped with the polarizer. For example, the conventional display device may include a shielding member having an increased length to cover lateral portions of the polarizer, or a polarizer having extended lateral portions, so that a user does not see the lateral portions of the polarizer. Accordingly, an overlapped region between the shielding member and the polarizer may be extended in the conventional display device. Additionally, because the polarizer is located on the display panel, the number of surfaces of the elements which may reflect an external light is increased. As a result, quality of the images of the display device may be deteriorated by the reflection of the external light.

### SUMMARY

Example embodiments of the present invention provide display devices having a configuration in which a linear polarization layer is separated from a phase retardation layer, and methods of manufacturing the display devices.

Example embodiments provide display devices capable of reducing an overlap region between a linearly polarizing layer and a shielding member by separating a phase retardation layer from the linearly polarizing layer.

Example embodiments provide methods of manufacturing display devices capable of reducing the overlap region between the linearly polarizing layer and the shielding layer by separating the phase retardation layer from the linearly polarizing layer.

According to one aspect of example embodiments, there is provided a display device including a display panel, an adhesive member, a transparent member, a shielding member, a phase retardation layer, and a linearly polarizing layer. The display panel may include a bottom substrate, a switching element on the bottom substrate, a light emitting structure on the switching element, and an encapsulation structure on the light emitting structure. The display panel may have a display region and a peripheral region substantially surrounding the display region. The adhesive member may be on the display panel. The transparent member may be on the adhesive member. The shielding member may be beneath a lower surface of the transparent member in the peripheral region. The phase retardation layer may be between the display panel and the adhesive member. The linearly polarizing layer may be between the adhesive member and the transparent member. The linearly polarizing layer may be partially overlapped with the shielding member.

In example embodiments, a region in which the linearly polarizing layer is partially overlapped with the shielding member may be in the peripheral region.

In example embodiments, when the linearly polarizing layer is partially overlapped with the shielding member, the display region of the display panel may be increased in accordance with a reduction of a width of the shielding member.

In example embodiments, when the linearly polarizing layer is partially overlapped with the shielding member, widths of the linearly polarizing layer and the phase retardation layer may be decreased.

In example embodiments, the encapsulation structure may include a rigid material, and the adhesive member may include a photopolymer resin layer.

In example embodiments, the display device may additionally include a touch screen panel on the phase retardation layer. For example, the encapsulation structure may include a flexible material.

In example embodiments, the adhesive member may include an optically transparent adhesive (OPA).

In example embodiments, the display device may additionally include a first adhesive layer between the display panel and the phase retardation layer, and a second adhesive layer between the transparent member and the linearly polarizing layer.

According to another aspect of example embodiments, there is provided a method of manufacturing a display device. In the method, there is provided a display panel including a bottom substrate, a switching element on the bottom substrate, a light emitting structure on the switching element, and an encapsulation structure on the light emitting structure. The display panel may have a display region and a peripheral region substantially surrounding the display region. A phase retardation layer may be formed on the display panel. A transparent member may be formed on the phase retardation layer. A shielding member may be formed beneath a lower surface of the transparent member. A linearly polarizing layer partially overlapped with the shielding member may be formed beneath the lower surface of the transparent member. The display panel and the transparent member may be combined by an adhesive member.

In example embodiments, a region where the linearly polarizing layer is partially overlapped with the shielding member may be in the peripheral region.

In example embodiments, when the linearly polarizing layer is partially overlapped with the shielding member, the display region of the display panel may be increased in accordance with a reduction of a width of the shielding member.

In example embodiments, when the linearly polarizing layer is partially overlapped with the shielding member, widths of the linearly polarizing layer and the phase retardation layer may be decreased.

In example embodiments, the encapsulation structure may include a rigid material, and the adhesive member may include a photopolymer resin layer.

In example embodiments, a touch screen panel may be additionally formed on the phase retardation layer.

In example embodiments, the touch screen panel may be formed on the phase retardation layer, and the encapsulation structure may be formed using a flexible material. Further, the adhesive member may be formed using an optically transparent adhesive.

In forming of the phase retardation layer according to example embodiments, a first adhesive layer may be additionally formed between the display panel and the phase retardation layer.

In example embodiments, the first adhesive layer may combine the display panel with the phase retardation layer.

In forming of the linearly polarizing layer according to example embodiments, a second adhesive layer may be additionally formed between the transparent member and the linearly polarizing layer.

In example embodiments, the second adhesive layer may combine the transparent member with the linearly polarizing layer.

According to example embodiments, the display device may ensure an enlarged display region, and may improve outside visibility thereof, because an overlap region in which the linearly polarizing layer is partially overlapped with a shielding member, is reduced by separating the linearly polarizing layer from the phase retardation layer. Further, lengths of the linearly polarizing layer and the phase retardation layer may be decreased, so manufacturing costs for the display device may be reduced.

### BRIEF DESCRIPTION OF THE DRAWINGS

Example embodiments can be understood in more detail from the following description taken in conjunction with the accompanying drawings, in which:

FIG. 1 is a cross-sectional view showing a display device;

FIG. 2 is a cross-sectional view illustrating a display device in accordance with example embodiments;

FIG. 3 is a cross-sectional view illustrating an example embodiment of a touch screen panel included in the display device of FIG. 2;

FIGS. 4A to 4E are cross-sectional views illustrating a method of manufacturing a display device in accordance with example embodiments;

FIG. 5 is a cross-sectional view illustrating a display device in accordance with some example embodiments;

FIG. 6 is a cross-sectional view illustrating an example embodiment of a touch screen panel included in the display device in FIG. 5; and

FIGS. 7A to 7E are cross-sectional views illustrating a method of manufacturing a display device in accordance with some example embodiments.

### DETAILED DESCRIPTION

Hereinafter, example embodiments of the present invention will be described in detail with reference to the accompanying drawings. In the drawings, identical or similar reference numerals may represent identical or similar elements.

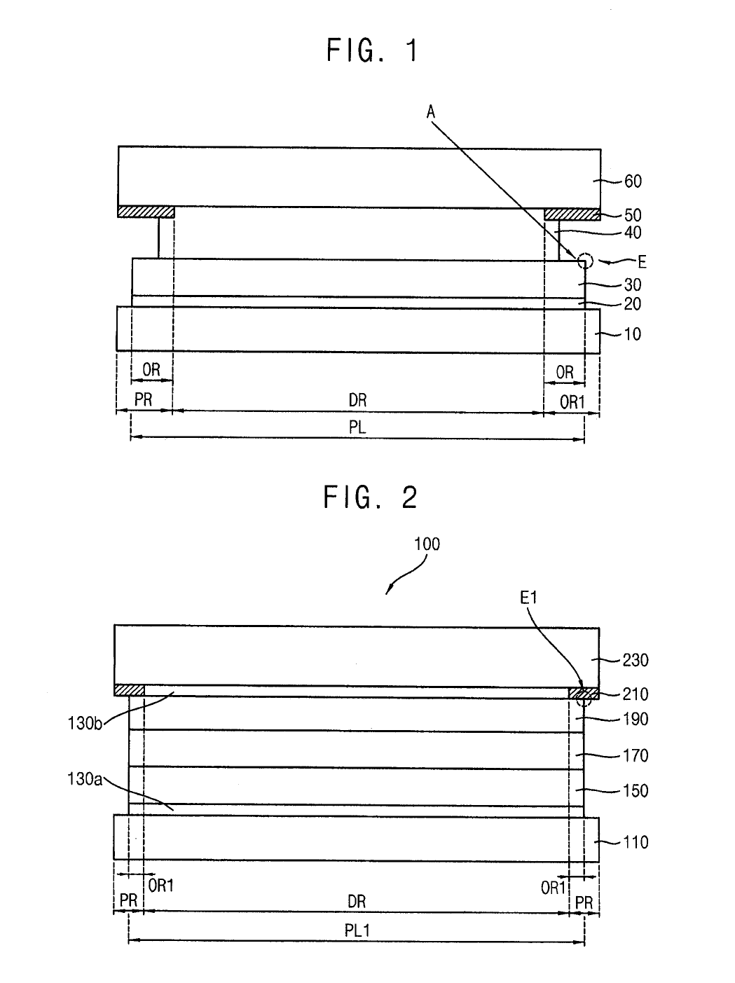

FIG. 1 is a cross-sectional view showing a display device. For example, the display device of FIG. 1 may be currently in use.

As illustrated in FIG. 1, the display device may include a display panel 10, an adhesive layer 20, a polarizer 30, an adhesive member 40, a shielding member 50, and a transparent member 60.

The adhesive layer 20 may be located on the display panel 10. The polarizer 30 may be located on the adhesive layer 20. The display panel 10 and the polarizer 30 may be combined together by the adhesive layer 20. The adhesive member 40 may be located on the polarizer 30. The transparent member 60 having the shielding member 50 may be positioned on the adhesive member 40. The shielding member 50 may be located at lateral portions (e.g., a peripheral region (PR)) of the transparent member 60. The display panel 10 including the polarizer 30 and the transparent member 60 having the shielding member 50 may be combined together by the adhesive member 40.

The polarizer 30 may be located between the display panel 10 and the adhesive member 40. In this case, a region where the polarizer 30 is overlapped with the shielding member 50 may be referred to as an overlap region (OR). In the display device of FIG. 1, when a user obliquely watches the display device as indicated in A portion, a length (PL) of the polarizer 30 or a length of the shielding member 50 is increased so that the user may not see both lateral portions (E) of the polarizer 30. Accordingly, the overlap region (OR) may have an enlarged size. In addition, the number of surfaces of elements which may reflect an external light (e.g., an upper surface of the transparent member 60, an interface between the transparent member 60 and the adhesive member 40, a lower surface of the adhesive member 40, etc.) may be increased because the polarizer 30 is positioned on the display panel 10. As a result, quality of images on the display device may be deteriorated due to a reflection of the external light.

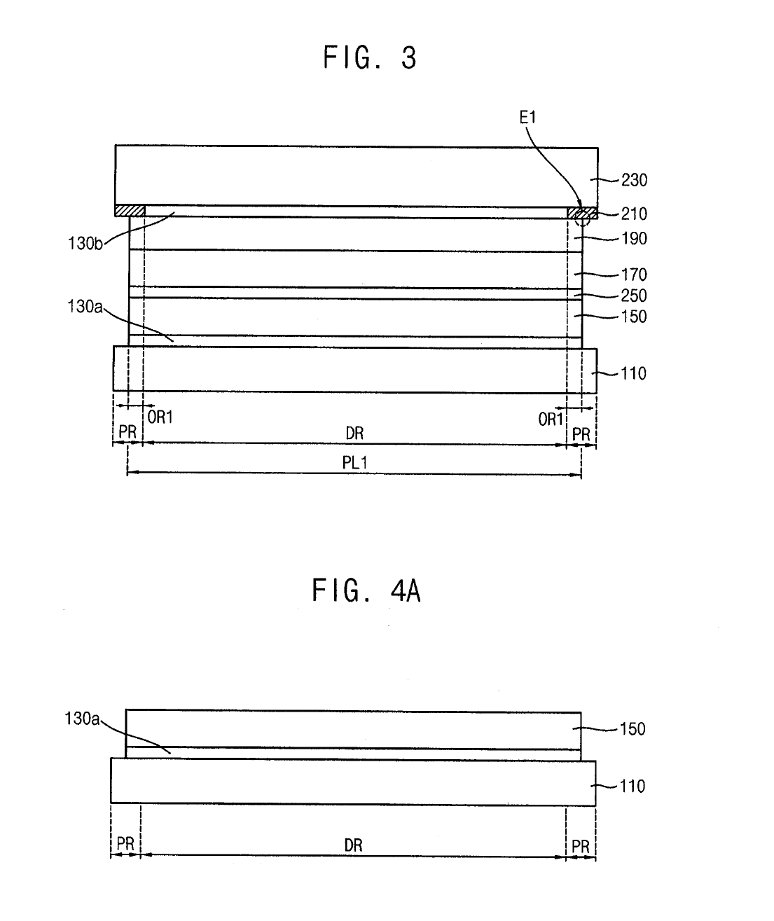

FIG. 2 is a cross-sectional view illustrating a display device in accordance with example embodiments. FIG. 3 is a cross-sectional view illustrating an example embodiment of a touch screen panel included in the display device of FIG. 2.

Referring to FIG. 2, a display device 100 according to example embodiments includes a display panel 110, a first adhesive layer 130a, a second adhesive layer 130b, a phase retardation layer 150, an adhesive member 170, a linearly polarizing layer 190, a shielding member 210, and a transparent member 230. In other embodiments, display devices may include one or more but not all of the components or features of the display device 100, and may also include other components or features not shown in FIG. 2.

In example embodiments, the display panel 110 may include a bottom substrate, a switching element, a light emitting structure, an encapsulation structure, etc. Here, the light emitting structure may include an anode electrode, a light emitting layer, a cathode electrode, etc.

The bottom substrate may have a display region (DR) and a peripheral region (PR). The bottom substrate may include a transparent inorganic material or flexible plastic. For example, the bottom substrate may include a rigid glass substrate or a quartz substrate. Alternatively, the bottom substrate may include a flexible transparent resin substrate. Here, the flexible transparent resin substrate for the bottom substrate may include a polyimide substrate. In this case, the polyimide substrate may include a first polyimide layer, a barrier film layer, a second polyimide layer, etc. In some example embodiments, the bottom substrate may have a stacked structure in which the first polyimide layer, the barrier film layer and the second polyimide layer are stacked on a glass substrate. Here, after an insulating layer is positioned on the second polyimide layer, upper structures may be positioned on the insulating layer. After the upper structures are provided, the glass substrate may be removed. It may be difficult that the upper structures are directly formed on the polyimide substrate because the polyimide substrate has a thin thickness and flexibility. Accordingly, after the upper structures are formed on a rigid glass substrate, the polyimide substrate may be used as the bottom substrate by removing the glass substrate.

The switching element may be located on the bottom substrate. The switching element may control an emission of a light from the light emitting structure. In example embodiments, the switching element may correspond to (e.g., may include) a semiconductor device which may include an active layer formed using oxide semiconductor, inorganic semiconductor (e.g., amorphous silicon, polysilicon, etc.), organic semiconductor, etc. The switching element may be electrically connected to the anode electrode. The anode electrode may be located on the switching element, and the cathode electrode may be located on the anode electrode. Each of the anode electrode and the cathode electrode may include metal, alloy, metal nitride, conductive metal oxide, a transparent conductive material, etc. For example, the anode and the cathode electrodes may include aluminum (Al), aluminum alloy, aluminum nitride (AINx), silver (Ag), silver alloy, tungsten (W), tungsten nitride (WNx), copper (Cu), copper alloy, nickel (Ni), chrome (Cr), chrome nitride (CrNx), molybdenum (Mo), molybdenum alloy, titanium (Ti), titanium nitride (TiNx), platinum (Pt), tantalum (Ta), tantalum nitride (TaNx), neodymium (Nd), scandium (Sc), strontium ruthenium oxide (SRO), zinc oxide (ZnOx), indium tin oxide (ITO), stannum oxide (SnOx), indium oxide (InOx), gallium oxide (GaOx), indium zinc oxide (IZO), etc. These may be used alone or in any suitable combinations thereof.

The light emitting layer may be positioned between the anode electrode and the cathode electrode. For example, the light emitting layer may have a multilayered structure including an organic light emitting layer (EL), a hole injection layer (HIL), a hole transport layer (HTL), an electron transport layer (ETL), an electron injection layer (EIL), etc. In example embodiments, the organic light emitting layer may include light emitting materials capable of generating different colors of light such as a red color light, a blue color light, and a green color light in accordance with the types of pixels in the display device 100. In some example embodiments, the organic light emitting layer may generally generate a white color light by stacking a plurality of light emitting materials capable of generating different color lights such as a red color light, a green color light, a blue color light, etc. The cathode electrode may be located on the light emitting layer.

The encapsulation structure may be provided on the cathode electrode. The encapsulation structure may be formed using a transparent insulation material, a flexible material, etc. For example, the encapsulation structure may include a glass substrate, a quartz substrate, a transparent resin substrate, etc. Alternatively, the encapsulation structure may have a stacked configuration in which at least one organic layer and at least one inorganic layer may be alternately stacked. In this case, the inorganic layer may include silicon oxide, silicon nitride, silicon oxynitride, silicon oxycarbide, silicon carbonitride, aluminum oxide, aluminum nitride, titanium oxide, zinc oxide, etc. Additionally, the organic layer may include acrylate monomer, phenylacetylene, diamine, dianhydride, siloxane, silane, parylene, olefin-based polymer, polyethylene terephthalate, fluorine resin, polysiloxane, etc.

The first adhesive layer 130a may be located on the display panel 110. The display panel 110 and the phase retardation layer 150 may be combined together by the first adhesive layer 130a. The first adhesive layer 130a may include a pressure sensitive adhesive (PSA). Examples of the PSA may include a urethane-based material, an acryl-based material, a silicon-based material, etc.

The phase retardation layer 150 may be located on the first adhesive layer 130a. In example embodiments, the phase retardation layer 150 may correspond to (e.g., may include) a λ/4 phase retardation layer. The λ/4 phase retardation layer may convert a phase of the light passing therethrough. For example, the λ/4 phase retardation layer may convert the light vibrating vertically or horizontally into a right-circularly polarized light or a left-circularly polarized light. In addition, the λ/4 phase retardation layer may convert the right-circularly polarized light or the left-circularly polarized light into the light vibrating vertically or horizontally. The phase retardation layer 150 may include a birefringent film containing polymer, an orientation film containing liquid crystal polymer, an alignment film containing a liquid crystal polymer, etc.

In some example embodiments, as illustrated in FIG. 3, a touch screen panel 250 may be positioned on the phase retardation layer 150. When the touch screen panel 250 is provided on the phase retardation layer 150, the encapsulation structure of the display panel 110 may include a flexible material. The touch screen panel 250 may include a lower PET film, touch screen panel electrodes, an upper PET film, etc. Each of the lower PET film and upper top PET film may protect the touch screen panel electrodes. In this case, the lower PET film may be replaced with the first adhesive layer 130a, and the upper PET film may be replaced with the adhesive member (or adhesive layer) 170. When the touch screen panel 250 is located on the phase retardation layer 150, the adhesive member 170 may include an optical clear adhesive (OCA). Accordingly, the touch screen panel electrodes may be positioned on the first adhesive layer 130a. Each of the touch screen panel electrodes may have a metal mesh structure. For example, each touch screen panel electrode may include carbon nano tube (CNT), transparent conductive oxide (TOO), indium tin oxide (ITO), indium gallium zinc oxide (IGZO), zinc oxide (ZnO), graphene, silver nanowire (AgNW), copper (Cu), chrome (Cr), etc.

The adhesive member 170 may be located on the phase retardation layer 150. The adhesive member 170 may be positioned between the linearly polarizing layer 190 and the phase retardation layer 150. Thus, the display panel 110 having the phase retardation layer 150 (and optionally the touch screen panel 250) thereon may be combined with the transparent member 230 having the shielding member 210 and the linearly polarizing layer 190 by the adhesive member 170. In example embodiments, when the encapsulation structure of the display panel 110 contains rigid glass, the adhesive member 170 may include photopolymer resin containing oligomer, urethane acrylate, monomer, photoinitiator, solvent, ketone, etc. Here, the adhesive member 170 including the photopolymer resin may have a relatively high light transmittance and a relatively high adhesion strength. In some example embodiments, when the encapsulation structure of the display panel 110 includes a flexible material, the adhesive member 170 may include OCA. As described above, when the touch screen panel 250 is located on the phase retardation layer 150, the touch screen panel electrodes may be effectively protected by the adhesive member 170.

The linearly polarizing layer 190 may be located on the adhesive member 170. The linearly polarizing layer 190 and the transparent member 230 may be combined together by the second adhesive layer 130b. In example embodiments, the linearly polarizing layer 190 and the shielding member 210 may be partially overlapped with each other.

In example embodiments, the linearly polarizing layer 190 may selectively transmit the light therethrough. For example, the linearly polarizing layer 190 may transmit the light vibrating vertically or horizontally. In this case, the linearly polarizing layer 190 may include horizontal stripe patterns or vertical stripe patterns. When the linearly polarizing layer 190 includes the horizontal stripe patterns, the linearly polarizing layer 190 may block the light vibrating vertically, and thus may only transmit the light vibrating horizontally. In a case where the linearly polarizing layer 190 includes the vertical stripe patterns, the linearly polarizing layer 190 may block the light vibrating horizontally, and thus may only transmit the light vibrating vertically. The light transmitted through the linearly polarizing layer 190 may also be transmitted through the phase retardation layer 150. As described above, the phase retardation layer 150 may convert the phase of the light. For example, when the external light vibrating in all directions passes through the linearly polarizing layer 190, the linearly polarizing layer 190 having the horizontal stripe patterns may transmit the external light vibrating horizontally. In a case where the external light vibrating horizontally passes through the phase retardation layer 150, the external light vibrating horizontally may be converted into the left-circularly polarized light. The external light including the left-circularly polarized component may be reflected at the cathode electrode of the display panel 110, and then the external light may be converted into the right-circularly polarized light. When the external light including the right-circularly polarized component passes through the phase retardation layer 150, the external light may be converted into the light vibrating vertically. Here, the light vibrating vertically may be blocked by the linearly polarizing layer 190 including the horizontal stripe patterns. Accordingly, such external light may be removed by the linearly polarizing layer 190 and the phase retardation layer 150. For example, the linearly polarizing layer 190 may include an iodine-based material, a material containing dye, a polyene-based material, etc. In example embodiments, when the transparent member 230 is located on the linearly polarizing layer 190, a region where the linearly polarizing layer 190 and the shielding member 210 are substantially overlapped may be referred to as a first overlap region (OR1).

In the display device illustrated in FIG. 1, the polarizer 30 is positioned on the display panel 10. In this case, a region where the polarizer 30 is overlapped with the shielding member 50 is referred to as the overlap region (OR). When the user obliquely watches the display device of FIG. 1 as denoted in A, the length (PL) of the polarizer 30 should be increased so that the user does not see both lateral portions (E) of the polarizer 30. Thus, the size of the overlap region (OR) is increased. In addition, the number of surfaces reflecting the external light (e.g., the upper surface of the transparent member 60, the interface between the transparent member 60 and the adhesive member 40, and the lower surface of the adhesive member 40) is increased because the polarizer 30 is located on the display panel 10. Therefore, the quality of the images of the display device of FIG. 1 may be deteriorated by the reflection of the external light. However, in example embodiments, as illustrated in FIG. 2, both of the lateral portions (E1) of the linearly polarizing layer 190 may be partially overlapped with the shielding member 210 so that the dimension of the first overlap region (OR1) of the linearly polarizing layer 190 and the shielding member 210 may be reduced. Therefore, the length of the display region (DR) in the display device 100 may be increased while the length of the shielding member 210 may be reduced. For example, the length of the shielding member 210 may be substantially the same as or substantially similar to the length of the peripheral region (PR). In a case where the display device 100 is assumed to have a dimension (e.g., the length of the display device 100) substantially the same as that of the display device of FIG. 1, the display device 100 may ensure the display region (DR) substantially larger than that of the display device of FIG. 1. A difference between the length of the first overlap region (OR1) and the length of the overlap region (OR) in FIG. 1 may be substantially the same as or substantially similar to a difference between the length of the shielding member 210 in FIG. 2 and the length of the shielding member 50 of FIG. 1. For example, the first overlap region (OR1) according to example embodiments may be substantially smaller than the overlap region (OR) shown in FIG. 1 by about 0.2 mm to about 0.4 mm. In addition, since the linearly polarizing layer 190 may be positioned directly adjacent to the shielding member 210, the number of surfaces reflecting the external light (e.g., the upper and lower surfaces of the transparent member 230) may be reduced. As a result, the quality of the images of the display device 100 may be improved. For example, an outside visibility of the display device 100 may be enhanced by above 0.5% over that of the display device of FIG. 1, for example. According to example embodiments, portions of polarizing layers may be located adjacent to the shielding member 210, so the length of the shielding member 210 may be reduced, and thus the length of the display region (DR) of the display device 100 may be increased.

The second adhesive layer 130b may be located on the linearly polarizing layer 190. The linearly polarizing layer 190 and the transparent member 230 may be combined together by the second adhesive layer 130b. The second adhesive layer 130b may include PSA. Examples of PSA may include a urethane-based material, an acryl-based material, a silicon-based material, etc.

The transparent member 230 may be located on the second adhesive layer 130b. The transparent member 230 may include a transparent plastic material. For example, the transparent member 230 may be composed of a plastic window. Here, the plastic window may include a plastic having transparency of above 95%, for example.

The shielding member 210 may be located beneath the lower surface of the transparent member 230. A width of the shielding member 210 may be substantially the same as or substantially similar to a width of the peripheral region (PR). The shielding member 210 may be positioned in the peripheral region (PR) of the transparent member 230. When the shielding member 210 is positioned in the peripheral region (PR) (e.g., a portion of the display device 100 in which the images may be not displayed) of the transparent member 230, the shielding member 210 may substantially cover wirings (e.g., lines and/or electrodes) positioned in the peripheral region (PR) which may substantially surround the display region (DR) (e.g., a portion of the display device 100 where the images are displayed). In addition, when the external light passes through the transparent member 230, the external light may not be reflected by the wirings covered with the shielding member 210. In example embodiments, the shielding member 210 may be formed using a black matrix which represents substantial black color. For example, the shielding member 210 may include carbon black and/or the like.

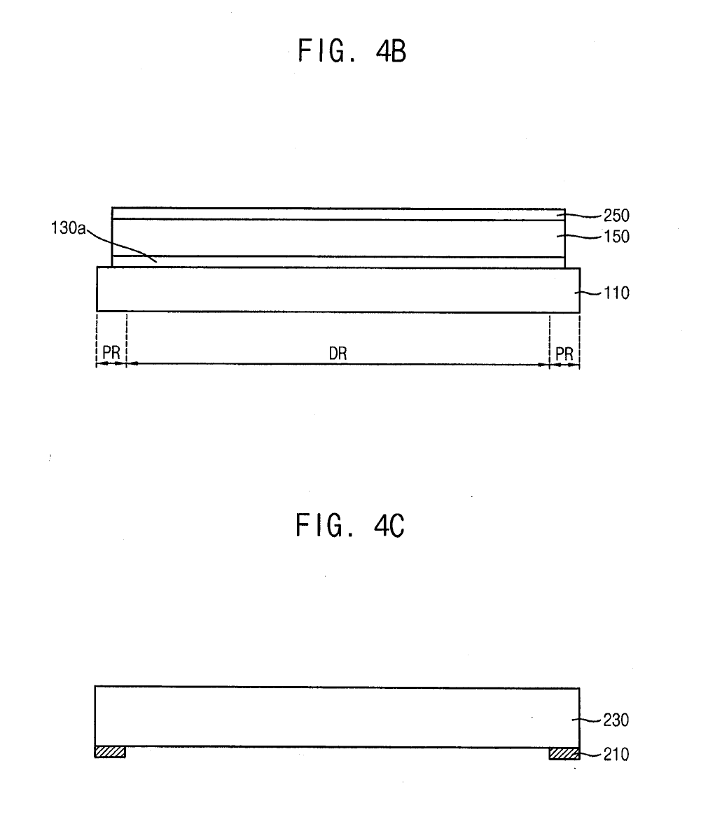

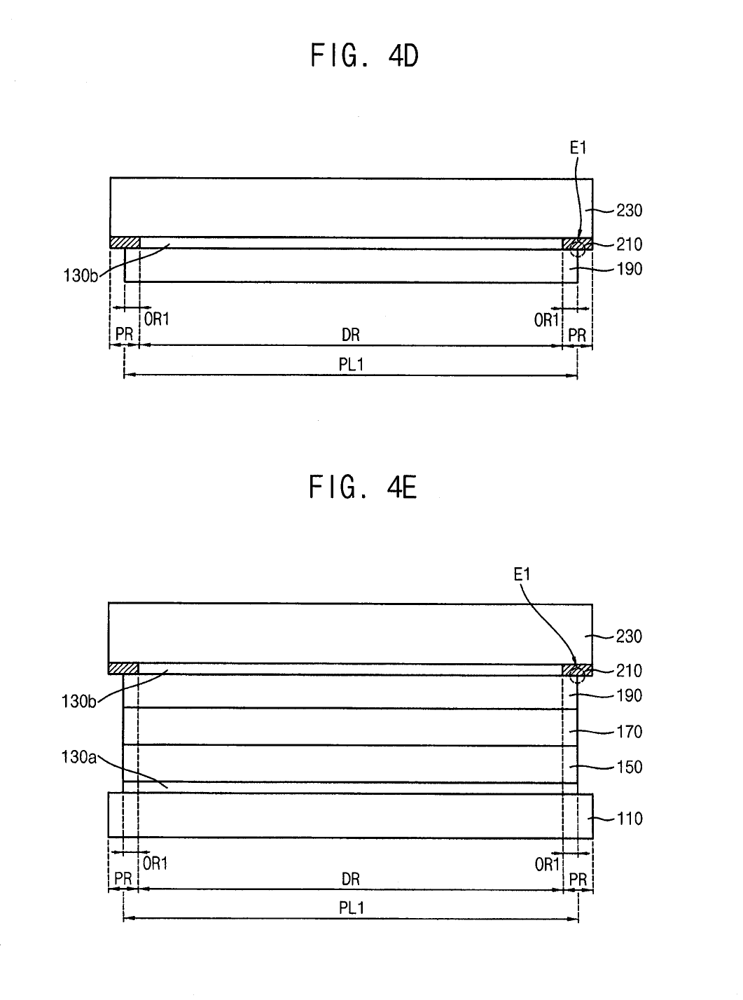

FIGS. 4A to 4E are cross-sectional views illustrating a method of manufacturing a display device in accordance with example embodiments.

Referring to FIG. 4A, a first adhesive layer 130a may be formed on a display panel 110. In example embodiments, the display panel 110 may include a bottom substrate, a light emitting structure, an encapsulation structure, etc. The bottom substrate may be formed using a transparent inorganic material or flexible plastic. A switching element including a thin film transistor (TFT) or an oxide semiconductor may be formed on the bottom substrate. The light emitting structure may include an anode electrode, a light emitting layer, a cathode electrode, etc. Here, the anode electrode may be electrically connected to the switching element. For example, the anode electrode may be formed using metal, alloy, metal nitride, conductive metal oxide, a transparent conductive material, etc. The light emitting layer may be formed on the anode electrode. The light emitting layer may have a multi-layered structure including an EL, an HIL, an HTL, an ETL, an EIL, etc. An organic light emitting layer for the light emitting layer may include light emitting materials capable of generating different color lights such as a red color light, a blue color light and a green color light in accordance with pixels in the display device. In some example embodiments, the organic light emitting layer may substantially generate a white color light when the organic light emitting layer has a stacked structure including a plurality of light emitting materials capable of generating different colors lights such as a red color light, a green color light, a blue color light, etc. The cathode electrode may be formed on the light emitting layer. For example, the cathode electrode may be formed using metal, alloy (e.g., a metal alloy), metal nitride, conductive metal oxide, a transparent conductive material, etc. The encapsulation structure may be provided on the cathode electrode.

The encapsulation structure may be formed using a transparent insulation material, a flexible material, etc. For example, the encapsulation structure may include a glass substrate, a quartz substrate, a transparent resin substrate, etc. Alternatively, the encapsulation structure may have a stacked configuration in which at least one organic layer and at least one inorganic layer are alternately stacked. For example, the inorganic layer may be formed using silicon oxide, silicon nitride, silicon oxynitride, silicon oxycarbide, silicon carbonitride, aluminum oxide, aluminum nitride, titanium oxide, zinc oxide, etc. The organic layer may be formed using acrylate monomer, phenylacetylene, diamine, dianhydride, siloxane, silane, parylene, olefin-based polymer, polyethylene terephthalate, fluorine resin, polysiloxane. etc.

As illustrated in FIG. 4A, the first adhesive layer 130a may be formed on the display panel 110 using PSA. Example of PSA for the first adhesive layer 130a may include an acryl-based polymer material and the like.

A phase retardation layer 150 may be formed on the first adhesive layer 130a. Here, the phase retardation layer 150 and the display panel 110 may be combined together by the first adhesive layer 130a. In example embodiments, the phase retardation layer 150 may correspond to a λ/4 phase retardation layer. For example, the phase retardation layer 150 may include a birefringent film containing polymer, an orientation film containing liquid crystal polymer, an alignment layer containing liquid crystal polymer, etc. In some example embodiments, a touch screen panel 250 may be formed on the phase retardation layer 150 as illustrated in FIG. 4B. When the touch screen panel 250 is formed on the phase retardation layer 150, the encapsulation structure of the display panel 110 may be formed using a flexible material. In general, the touch screen panel 250 may include a lower PET film, touch screen panel electrodes, an upper PET film, etc. The lower PET film and the upper PET film may substantially protect the touch screen panel electrodes. In some example embodiments, the lower PET film may be replaced with the first adhesive layer 130a, and also the upper PET film may be replaced with an adhesive member 170. Here, the touch screen panel electrodes may be formed on the first adhesive layer 130a. The touch screen panel electrodes may have a substantial metal mesh structure. For example, each of the touch screen panel electrodes may be formed using CNT, TCO, ITO, IGZO, ZnO, AgNW, Cu, Cr, etc.

Referring to FIG. 4C, a shielding member 210 may be formed beneath a lower surface of the transparent member 230. The transparent member 230 may be formed using a transparent plastic material. For example, the transparent member 230 may include a plastic window. Here, the plastic window may include a plastic having transparency of above 95%, for example.

The shielding member 210 may be positioned in a peripheral region (PR) of the transparent member 230. When the shielding member 210 is formed in the peripheral region (PR) (e.g., images may not be displayed) of the transparent member 230, the shielding member 210 may substantially cover wirings (e.g., lines and/or electrodes) positioned in the peripheral region (PR), which substantially surround the display region (DR) (e.g., images may be displayed). In a case where an external light passes through the transparent member 230, the external light may not be reflected by the wirings. In example embodiments, the shielding member 210 may be formed using a black matrix representing substantially black color. For example, the shielding member 210 may include carbon black.

Referring to FIG. 4D, a second adhesive layer 130b may be formed beneath the lower surface of the transparent member 230. The second adhesive layer 130b may be formed using PSA. Examples of PSA may include an acryl-based polymer material. The second adhesive layer 130b may contact with the shielding member 210. For example, the second adhesive layer 130b may be located in the display region (DR) while the second adhesive layer 130b makes contact with the shielding member 210.

A linearly polarizing layer 190 may be formed beneath the second adhesive layer 130b. The linearly polarizing layer 190 and the transparent member 230 may be combined together by the second adhesive layer 130b. While the linearly polarizing layer 190 is partially overlapped with the shielding member 210, the linearly polarizing layer 190 may be formed in the display region (DR).

In example embodiments, the linearly polarizing layer 190 may include horizontal stripe patterns or vertical stripe patterns. For example, the linearly polarizing layer 190 may include an iodine-based material, a material containing dye, a polyene-based material, etc. When the transparent member 230 is formed on the linearly polarizing layer 190, a region where the linearly polarizing layer 190 is substantially overlapped with the shielding member 210 is referred to as a first overlap region (OR1).

The polarizer 30 of FIG. 1 is formed on the display panel 10. In this case, the region where the polarizer 30 and the shielding member 50 are substantially overlapped is defined as the overlap region (OR). When the user obliquely watches the display device, the length PL of polarizer 30 should be increased so that the user may not see the lateral portions (E) of the polarizer 30. Hence, the size of the overlap region (OR) is also increased. Further, the number of surfaces reflecting the external light is increased because the polarizer 30 is formed on the display panel 10. Thus, the quality of the images of the display device of FIG. 1 may be deteriorated by the reflection of the external light. However, in example embodiments, since both of the lateral portions (E1) of the linearly polarizing layer 190 are partially overlapped with the shielding member 210 as illustrated in FIG. 4D, the first overlap region (OR1) between the linearly polarizing layer 190 and the shielding member 210 may be reduced. Hence, the length of the display region (DR) may be increased whereas the length of the shielding member 210 may be decreased. The length of the shielding member 210 may be substantially the same as or substantially similar to the length of the peripheral region (PR). When the display device 100 has the dimension substantially the same as or substantially similar to that of the display device of FIG. 1, the display device 100 may ensure the display region (DR) substantially larger than that of the display device of FIG. 1. The difference between the length of the first overlap region (OR1) and the length of the overlap region (OR) of FIG. 1 may be substantially the same as or substantially similar to the difference between the length of the shielding member 210 in FIG. 2 and the length of the shielding member 50 of FIG. 1. For example, the first overlap region (OR1) according to example embodiments may be substantially smaller than the overlap region (OR) of FIG. 1 by about 0.2 mm to about 0.4 mm. Further, the linearly polarizing layer 190 may be formed directly adjacent to the shielding member 210, so the number of surfaces reflecting the external light (e.g., the upper and lower surfaces of the transparent member 230) may be reduced. As a result, the quality of the images of the display device 100 may be improved. For example, the outside visibility of the display device 100 may be enhanced by above 0.5% over that of the display device of FIG. 1, for example. As the portions of polarized layers may be formed adjacent to the shielding member 210, the length of the shielding member 210 may be decreased, and thus the length of the display region (DR) of the display device 100 may be increased.

Referring to FIG. 4E, an adhesive member 170 may be formed between the linearly polarizing layer 190 and the phase retardation layer 150. Accordingly, the display panel 110 having the phase retardation layer 150 (and optionally the touch screen panel 250) and the transparent member 230 having the shielding member 210 and the linearly polarizing layer 190 may be combined together by the adhesive member 170. In example embodiments, when an encapsulation structure of the display panel 110 is formed using a rigid glass material, the adhesive member 170 may be formed using photopolymer resin containing oligomer, urethane acrylate, monomer, photoinitiator, solvent, ketone, etc. Here, the adhesive member 170 containing the photopolymer resin may have a high transmittance and a high adhesion strength. In some example embodiments, when the encapsulation structure of the display panel 110 is formed using a flexible material, the adhesive member 170 may be formed using OCA.

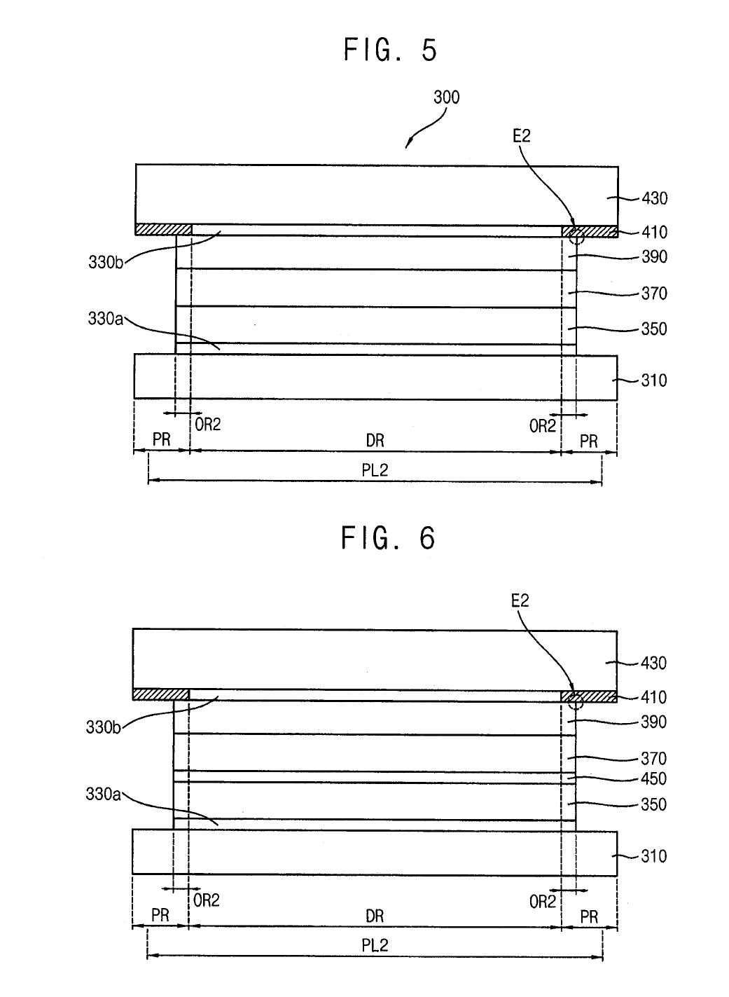

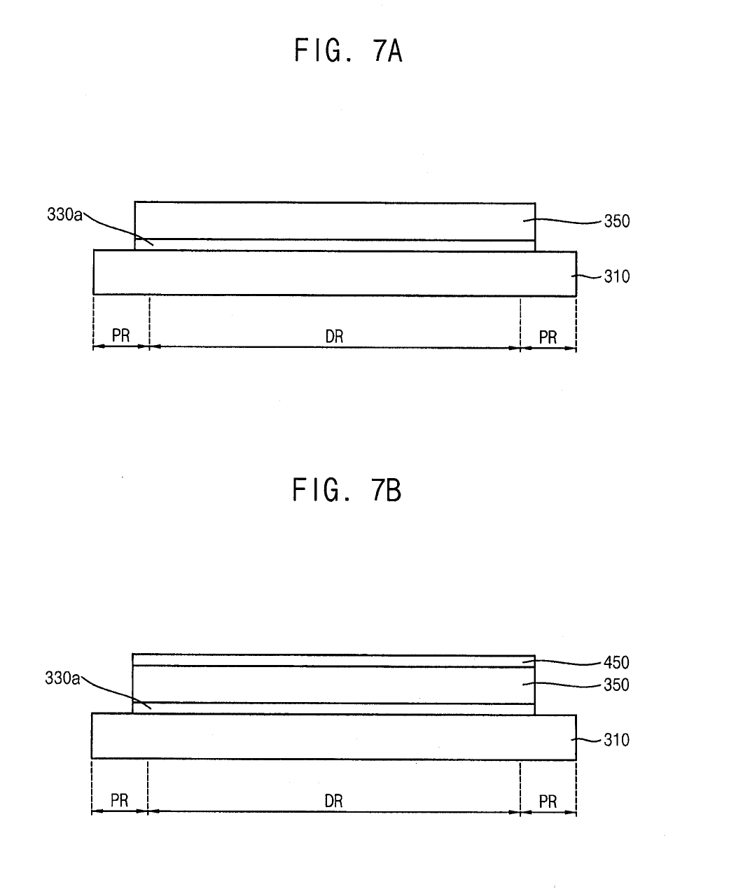

FIG. 5 is a cross-sectional view illustrating a display device in accordance with some example embodiments. FIG. 6 is a cross-sectional view illustrating an example of a touch screen panel included in the display device in FIG. 5. A display device 300 illustrated in FIG. 5 and the display device of FIG. 6 further including a touch screen panel may have a configuration substantially the same as or substantially similar to that of the display device 100 of FIG. 2 or the display device of FIG. 3, except for a second overlap region (OR2) in which a linearly polarizing layer 390 and a shielding member 410 light are substantially overlapped with each other. In FIGS. 5 and 6, detailed descriptions for elements, which are substantially the same as or substantially similar to the elements in FIGS. 2 and 3 may be omitted.

The display device 300 of FIG. 5 and the display device of FIG. 6 each may include a display panel 310, a first adhesive layer 330a, a second adhesive layer 330b, a phase retardation layer 350, an adhesive member 370, the linearly polarizing layer 390, the shielding member 410, a transparent member 430, etc.

In example embodiments, the display panel 310 may include a bottom substrate, a switching element, a light emitting structure, and an encapsulation structure, etc. In addition, the light emitting structure may include an anode electrode, a light emitting layer, a cathode electrode, etc.

The first adhesive layer 330a may be located on the display panel 310. The phase retardation layer 350 may be positioned on the first adhesive layer 330a. The display panel 310 may have a display region (DR) and a peripheral region (PR). The display panel 310 and the phase retardation layer 350 may be combined together by the first adhesive layer 330a.

In some example embodiments, as illustrated in FIG. 6, a touch screen panel 450 may be located on the phase retardation layer 350. When the touch screen panel 450 is formed on the phase retardation layer 350, the encapsulation structure of the display panel 310 may include a flexible material.

The adhesive member 370 may be located on the phase retardation layer 350. The adhesive member 370 may be located between the linearly polarizing layer 390 and the phase retardation layer 350. Hence, the display panel 310 including the phase retardation layer 350 (and optionally the touch screen panel 450) and the transparent member 430 including the shielding member 410 and the linearly polarizing layer 390 may be combined together by the adhesive member 370.

The linearly polarizing layer 390 may be positioned on the adhesive member 370. The linearly polarizing layer 390 and the transparent member 430 may be combined together by the second adhesive layer 330b. While the linearly polarizing layer 390 and the shielding member 410 are partially overlapped with each other, the linearly polarizing layer 390 may be positioned in the display region (DR). When the linearly polarizing layer 390 is provided beneath the transparent member 430, a region in which the linearly polarization layer 390 is substantially overlapped with the shielding member 410 is referred to as the second overlap region (OR2).

As illustrated in FIG. 1, the polarizer 30 is located on the display panel 10, so the polarizer 30 is overlapped with the shielding member 50 in the overlap region (OR). When the user obliquely watches the display device of FIG. 1, the length (PL) of polarizer 30 should be enlarged to cover the lateral portions (E) of the polarizer 30 from the user so that the overlap region (OR) has an increased size. The number of surfaces reflecting the external light is also increased because the polarizer 30 is located on the display panel 10. Therefore, the quality of the images of the display device of FIG. 1 is deteriorated by the reflection of the external light. According to example embodiments, as illustrated in FIG. 6, both of lateral portions (E2) of the linearly polarizing layer 190 may be partially overlapped with the shielding member 410 so that the second overlap region (OR2) between the linearly polarizing layer 390 and the shielding member 410 may be decreased. Accordingly, a length (PL2) of the linearly polarizing layer 390 and a length of the phase retardation layer 350 may be decreased. The length of the shielding member 410 may be substantially the same as or substantially similar to the length of the peripheral region (PR). When the display device 300 has dimensions substantially the same as or substantially similar to those of the display device of FIG. 1, the display device 300 may ensure reduced lengths of the linearly polarizing layer 390 and the phase retardation layer 350. The width of the first overlap region (OR1) in FIG. 2 may be substantially the same as or substantially similar to a width of the second overlap region (OR2) in FIG. 5. However, the width of the peripheral region (PR) in FIG. 2 is different from the width of the peripheral region (PR) in FIG. 5. As described above, the width of the peripheral regions (PR) of FIG. 2 and FIG. 5 may be substantially the same as or substantially similar to the widths of the shielding members 210 and 410, respectively. Further, the width of the linearly polarizing layer 190 in FIG. 2 is different from the width of the linearly polarizing layer 390 in FIG. 5. Thus, the difference between the length of the first overlap region (OR1) of FIG. 2 and the length of the overlapped region (OR) of FIG. 1 may be substantially the same as or substantially similar to the difference between the length of the shielding member 210 in FIG. 2 and the length of the shielding member 50 of FIG. 1. Further, a difference between the length of the second overlap region (OR2) (e.g., a reduced length of the second overlap region (OR2)) of FIG. 5 and the length of the overlapped region (OR) of FIG. 1 may be substantially the same as or substantially similar to the difference between the lengths of the linearly polarizing layer 390 in FIG. 5 and the phase retardation layer 350 (e.g., reduced lengths of the linear polarization layer 390 and the phase retardation layer 350) and the length of the polarizer 30 of FIG. 1. For example, the second overlap region (OR2) according to example embodiments may be substantially smaller than the overlap region (OR) of FIG. 1 by about 0.2 mm to about 0.4 mm. Additionally, the linearly polarizing layer 390 may be formed directly adjacent to the shielding member 410, such that the number of surfaces reflecting the external light (e.g., the upper and lower surfaces of the transparent member 430) may be also reduced. As a result, the quality of the images of the display device 300 may be enhanced. For example, the outside visibility of the display device 300 may be improved by above 0.5% over that of the display device of FIG. 1, for example. Since portions of polarizing layers may be formed adjacent to the shielding member 410, the lengths of the polarizing layers (e.g., the linearly polarizing layer 390, the phase retardation layer 350, etc.) may have reduced sizes. Thus, manufacturing costs for the display device 300 may also be reduced.

A second adhesive layer 330b may be located on the linearly polarizing layer 390. The linearly polarizing layer 390 and the transparent member 430 may be combined together by the second adhesive layer 330b. The second adhesive layer 330b may include PSA. Examples of PSA may include a urethane-based material, an acryl-based material, a silicon-based material, etc.

The transparent member 430 may be positioned on the second adhesive layer 330b. The transparent member 430 may include a transparent plastic material. For example, the transparent member 430 may be formed using a plastic window having a transparency of above 95%.

The shielding member 410 may be located beneath the lower surface of the transparent member 430. The width of the shielding member 410 may be substantially the same as or substantially similar to the width of the peripheral region (PR). The shielding member 410 may be positioned in the peripheral region (PR) of the transparent member 430. When the shielding member 410 is located in the peripheral region (PR) of the transparent member 430, wirings in the peripheral region PR may be covered with the shielding member 410. Additionally, when the external light passes through the transparent member 430, the reflection of the external light may be reduced or prevented. In example embodiments, the shielding member 410 may be formed using a black matrix such as carbon black.

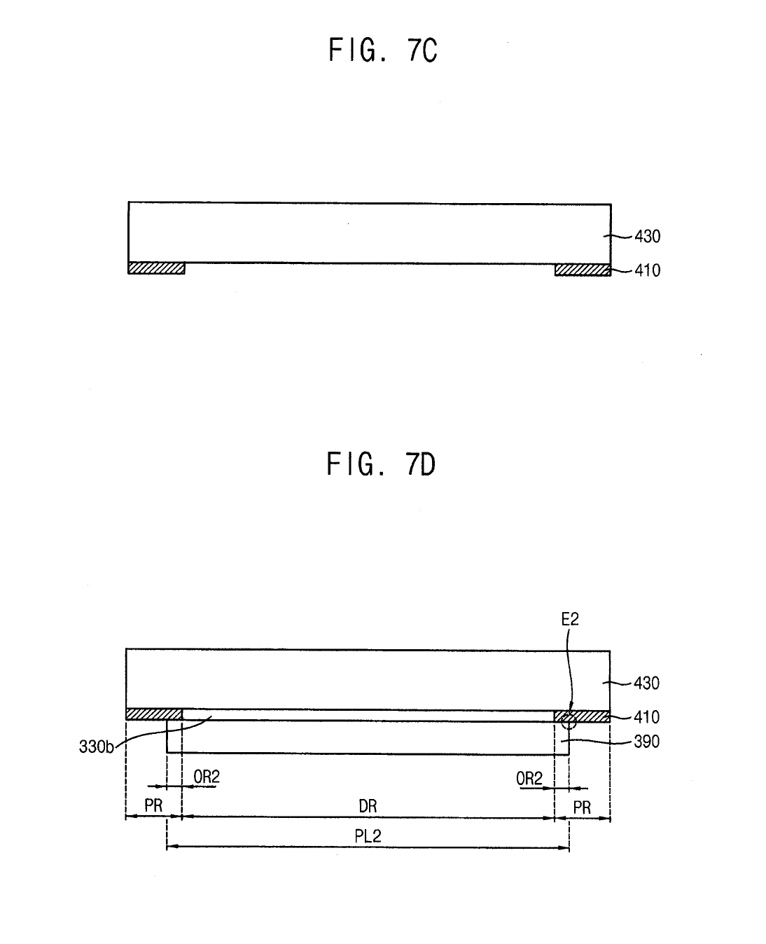

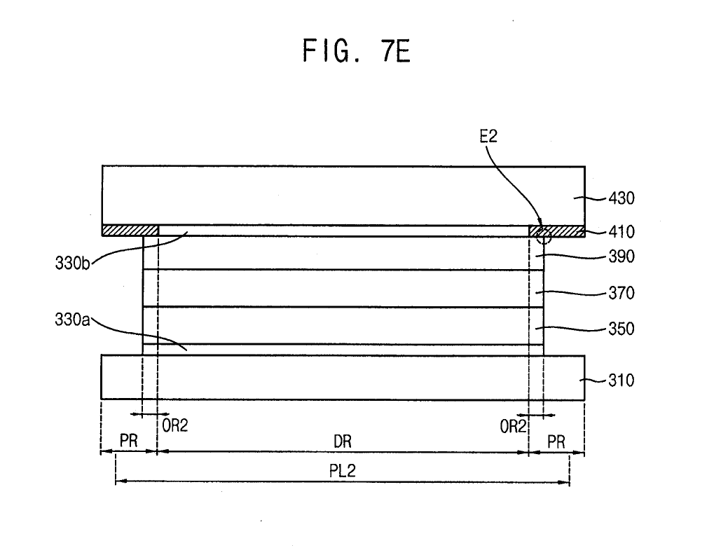

FIGS. 7A to 7E are cross-sectional views illustrating a method of manufacturing a display device in accordance with some example embodiments. The display device illustrated in FIGS. 7A to 7E may have a configuration substantially the same as or substantially similar to that of the display device described with reference to FIGS. 4A to 4E, except for a second overlap region (OR2) in which the linearly polarizing layer 390 is substantially overlapped with a shielding member 410. In FIGS. 7A to 7E, detailed descriptions for elements, which are substantially the same as or substantially similar to the elements in FIGS. 4A to 4E may be omitted.

Referring to FIG. 7A, the first adhesive layer 330a may be formed on the display panel 310. In example embodiments, the display panel 310 may include the bottom substrate, the light emitting structure, the encapsulation structure, etc. The switching element including a TFT or an oxide semiconductor may be formed on the bottom substrate. The light emitting structure may include an anode electrode, a light emitting layer, a cathode electrode, etc. Here, the anode electrode may be electrically connected to the switching element. The first adhesive layer 330a may be formed using PSA.

The phase retardation layer 350 may be formed on the first adhesive layer 330a. Here, the phase retardation layer 350 and the display panel 310 may be combined together by the first adhesive layer 330a. In example embodiments, the phase retardation layer 350 may correspond to a λ/4 phase retardation layer. For example, the phase retardation layer 350 may include a birefringent film containing polymer, an orientation film containing a liquid crystal polymer, an alignment layer containing a liquid crystal polymer, etc. In some example embodiments, as illustrated in FIG. 7B, a touch screen panel 450 may be formed on the phase retardation layer 350. When the touch screen panel 450 is formed on the phase retardation layer 350, the encapsulation structure of the display panel 310 may be formed using a flexible material. The touch screen panel 450 may include a lower PET film, touch screen panel electrodes, an upper PET film, etc. The lower and the upper PET films may protect the touch screen panel electrodes. In some example embodiments, the lower PET film may be replaced with the first adhesive layer 330a, and also the upper PET film may be replaced with the adhesive member 370. Here, the touch screen panel electrodes may be formed on the first adhesive layer 330a.

Referring to FIG. 7C, the shielding member 410 may be substantially formed in the peripheral region PR of the transparent member 430. When the shielding member 410 is located in the peripheral region (PR) of the transparent member 430, wirings substantially surrounding the display region DR may be covered with the shielding member 410. When the external light passes through the transparent member 430, the external light may not be reflected because the wirings are covered with the shielding member 410. For example, the shielding member 410 may be formed using a black matrix.

Referring to FIG. 7D, the second adhesive layer 330b may be formed on a lower surface of the transparent member 430. The second adhesive layer 330b may be formed using PSA. The second adhesive layer 330b may contact the shielding member 410. For example, the second adhesive layer 330b may be formed in the display region (DR) while the second adhesive layer 330b is contacting the shielding member 410.

The linearly polarizing layer 390 may be formed beneath the second adhesive layer 330b. The linearly polarizing layer 390 and the transparent member 430 may be combined together by the second adhesive layer 330b. While the linear polarization layer 390 may be partially overlapped with the shielding member 410, the linear polarization layer 390 may be formed in the display region (DR).

As illustrated in FIG. 7D, both of the lateral portions (E2) of the linearly polarizing layer 390 may be partially overlapped with the shielding member 410, such that the second overlap region (OR2) between the linearly polarizing layer 390 and the shielding member 410 may be reduced. Accordingly, the length (PL2) of the linearly polarizing layer 390 and the length of the phase retardation layer 350 may be decreased. The length of the shielding member 410 may be substantially the same as or substantially similar to the length of the peripheral region (PR). In a case where the display device 300 has a size substantially the same as or substantially similar to that of the display device of FIG. 1, the display device 300 may ensure the reduced lengths of the linear polarization layer 390 and the phase retardation layer 350. The first overlap region (OR1) of FIG. 2 may be substantially the same as or substantially similar to the width of the second overlap region (OR2) of FIG. 5. However, the width of the peripheral region (PR) in FIG. 2 may be different from the width of the peripheral region (PR) in FIG. 5. As described above, the width of the peripheral region (PR) of FIG. 2 and the width of the PR of FIG. 5 may be substantially the same as or substantially similar to the widths of the shielding members 210 and 410, respectively. Further, the width of the linearly polarizing layer 190 in FIG. 2 may be different from the width of the linearly polarizing layer 390 in FIG. 5. As a result, the difference between the length of the first overlap region (OR1) of FIG. 2 and the length of the overlap region (OR) of FIG. 1 may be substantially the same as or substantially similar to the difference between the length of the shielding member 210 in FIG. 2 and the length of the shielding member 50 of FIG. 1. The difference between the length of the second overlap region (OR2) and the length of the overlap region (OR) of FIG. 1 may be substantially the same as or substantially similar to the difference between the lengths of the linearly polarizing layer 390 in FIG. 5 and the phase retardation layer 350 and the length of the polarizer 30 of FIG. 1. For example, the second overlap region (OR2) according to example embodiments may be substantially smaller than the overlap region (OR) of FIG. 1 by about 0.2 mm to about 0.4 mm. Furthermore, since the linearly polarizing layer 390 may be formed directly adjacent to the shielding member 410, the number of surfaces reflecting the external light (e.g., the upper and lower surfaces of the transparent member 430) may also be reduced. As a result, the quality of the images of the display device 300 may be improved. For example, the outside visibility of the display device 300 may be enhanced by above 0.5% of that of the display device of FIG. 1. According to example embodiments, portions of polarizing layers may be formed adjacent to the shielding member 410, and the lengths of the polarizing layers may be decreased to thereby reduce manufacturing costs for the display device 300.

Referring to FIG. 7E, the adhesive member 370 may be formed between the linearly polarizing layer 390 and the phase retardation layer 350. Thus, the display panel 310 including the phase retardation layer 350 (and optionally the touch screen panel 450) and the transparent member 430 including the shielding member 410 and the linearly polarizing layer 390 may be combined together by the adhesive member 370. When the encapsulation structure of the display panel 310 is formed using a rigid glass material, the adhesive member 370 may be formed using a photopolymer resin containing oligomer, urethane acrylate, monomer, photoinitiator, solvent, ketone, etc. Here, the adhesive member 370 containing the photopolymer resin may have a high transmittance and a high adhesion function. In some example embodiments, when the encapsulation structure of the display panel 310 is formed using a flexible material, the adhesive member 370 may be formed using OCA.

The display device according to example embodiments may be employed in various electronic devices including a polarizer. For example, the display device according to example embodiments may be applied in a mobile phone, a smart phone, a laptop, a tablet, a computer, a personal digital assistant (PDA), a portable multimedia player (PMP), a digital camera, a music player (e.g., an MP3 player), a portable game console, a navigation system, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims and their equivalents.

What is claimed is:

1. A display device comprising:
a display panel having a display region and a peripheral region surrounding the display region, the display panel comprising a bottom substrate, a switching element on the bottom substrate, a light emitting structure on the switching element, and an encapsulation structure on the light emitting structure;
an adhesive member on the display panel;
a transparent member on the adhesive member;
a shielding member beneath a lower surface of the transparent member in the peripheral region;
a phase retardation layer between the display panel and the adhesive member; and
a linearly polarizing layer between the adhesive member and the transparent member, the linearly polarizing layer being partially overlapped with the shielding member.

2. The display device of claim 1, wherein a region where the linearly polarizing layer is partially overlapped with the shielding member is in the peripheral region.

3. The display device of claim 2, wherein when the linearly polarizing layer is partially overlapped with the shielding member, the display region of the display panel is increased in accordance with a reduction of a width of the shielding member.

4. The display device of claim 2, wherein when the linearly polarizing layer is partially overlapped with the shielding member, widths of the linearly polarizing layer and the phase retardation layer are decreased.

5. The display device of claim 1, wherein the adhesive member comprises a photopolymer resin layer and the encapsulation structure comprises a rigid material.

6. The display device of claim 1, further comprising a touch screen panel on the phase retardation layer.

7. The display device of claim 6, wherein the encapsulation structure comprises a flexible material.

8. The display device of claim 7, wherein the adhesive member comprises an optically transparent adhesive (OPA).

9. The display device of claim 1, further comprising:
a first adhesive layer between the display panel and the phase retardation layer; and
a second adhesive layer between the transparent member and the linearly polarizing layer.

10. A method of manufacturing a display device, the method comprising:
providing a display panel having a display region and a peripheral region surrounding the display region, the display panel comprising a bottom substrate, a switching element on the bottom substrate, a light emitting structure on the switching element, and an encapsulation structure on the light emitting structure;
forming a phase retardation layer on the display panel;
forming a shielding member beneath a lower surface of a transparent member;
forming a linearly polarizing layer beneath a lower surface of the transparent member to be partially overlapped with the shielding member; and
combining the display panel and the transparent member by an adhesive member.

11. The method of claim 10, wherein a region where the linearly polarizing layer is partially overlapped with the shielding member is in the peripheral region.

12. The method of claim 11, wherein when the linearly polarizing layer is partially overlapped with the shielding member, the display region of the display panel is increased in accordance with a reduction of a width of the shielding member.

13. The method of claim 11, wherein when the linearly polarizing layer is partially overlapped with the shielding member, widths of the linearly polarizing layer and the phase retardation layer are decreased.

14. The method of claim 10, wherein the adhesive member comprises a photopolymer resin layer and the encapsulation structure comprises a rigid material.

15. The method of claim 10, further comprising:
forming a touch screen panel on the phase retardation layer.

16. The method of claim 15, wherein the touch screen panel is formed on the phase retardation layer, the encapsulation structure is formed using a flexible material, and the adhesive member is formed using an optically transparent adhesive.

17. The method of claim 10, wherein the forming of the phase retardation layer on the display panel comprises:
forming a first adhesive layer between the display panel and the phase retardation layer.

18. The method of claim 17, wherein the first adhesive layer combines the display panel with the phase retardation layer.

19. The method of claim 10, wherein the forming of the linearly polarizing layer partially overlapped with the shielding member comprises forming a second adhesive layer between the transparent member and the linearly polarizing layer.

20. The method of manufacturing a display device of claim 19, wherein the second adhesive layer combines the transparent member with the linearly polarizing layer.
